(19) United States
(12) Patent Application Publication
(10) Pub. No.: US 2007/0040859 A1
(43) Pub. Date: Feb. 22, 2007

(54) LIQUID CONTAINER AND LIQUID EJECTION DEVICE

(76) Inventor: Hitotoshi Kimura, Nagano (JP)

Correspondence Address: STROOCK & STROOCK & LAVAN LLP, 180 MAIDEN LANE, NEW YORK, NY, 10038, US

(21) Appl. No.: 11/464,662

(22) Filed: Aug. 15, 2006

(30) Foreign Application Priority Data
Aug. 16, 2005 (JP) P2005-236016

(51) Int. Cl. B41J 2/195

(52) U.S. Cl. 347/7; 347/19

(57) ABSTRACT

The cartridge 20 stores the ink liquid supplied to the ink-jet head 15 of the ink-jet printer 10 in the ink pouch 23, and includes: a liquid supply port 26 for allowing the ink liquid stored in the ink pouch 23 to be supplied to the ink supply tube 18 of the printer by connecting a liquid supply needle (not shown in the drawing) provided in the cartridge mounting portion when the ink cartridge is mounted on the cartridge mounting portion of the ink-jet printer 10; a remaining amount detection sensor 27 which outputs a predetermined electric signal for notifying the main controller 14 of the ink-jet printer 10 of a fact that the remaining amount of the ink liquid reaches the near end when the remaining amount of the ink liquid stored in the ink pouch 23 is consumed to the threshold value which is the near end; and an information memory 33 from/to which information is readable and writable by the main controller 14 of the ink-jet printer 10. The information memory 33 stores correction information for correction the detection error of the remaining amount detection sensor 27 when the near end is detected.

### BACKGROUND OF THE INVENTION

1. Technical Field of the Invention

The present invention relates to a liquid container for supplying stored liquid to a liquid ejection device and a liquid ejection device on which the liquid container is mounted.

2. Description of the Related Art

Examples of the liquid container and the liquid ejection device may include an ink cartridge for storing ink and an ink-jet printer on which the ink cartridge is exchangeably mounted.

An ink cartridge for an ink-jet printer has an ink supply port for supplying the ink liquid stored in the cartridge chamber to the printer. The ink liquid stored in the cartridge chamber can be supplied to the printer by inserting an ink supply needle provided in the cartridge mounting portion into the ink supply port when the ink cartridge is mounted on the cartridge mounting portion of the printer.

In addition, in order to prevent an idle ejection of the print head in the printer, which can be caused when the ink liquid stored in the ink cartridge is completely exhausted, there has been proposed an ink cartridge comprising a remaining amount detection sensor which outputs a predetermined electric signal when the remaining amount of the stored ink liquid is exhausted to a predetermined threshold value (refer to Japanese Unexamined Patent Publication No. 2004-351871).

In this case, a near end is notified from the remaining amount detection sensor of the ink cartridge to a controller of the printer. The controller of the printer controls subsequent print processes such that the remaining ink liquid amount does not fall down under the threshold value where the near end is detect, thereby preventing an idle ejection of the print head.

Recently, in some color ink-jet printers, a part of the color inks can be exchanged with another color ink in a halfway when a print mode is changed. In the case of this usage, a history including what kind of the ink is used or whether or not the color ink has been exchanged should be managed, so that an ink cartridge having an information memory (a memory device) read and written by the controller of the printer in order to store an ink type or a use history has been proposed in the art (refer to Japanese Unexamined Patent Publication No. 2001-147146).

On the other hand, various methods have been proposed to detect the remaining ink liquid amount in the ink cartridge. For example, there have been proposed a method of detecting a liquid surface level of the ink using a float floating on the ink, a method of detecting bubbles generated by the external air introduced to the ink chamber at a predetermined location when the ink is exhausted, and a method of detecting an electrostatic capacity or an ink pressure that can be changed according to the remaining ink amount, and the like. However, different sensors should be employed according to the different detection method.

What kind of sensor element is used to commercially manufacture the ink cartridge, variations are generated in detection accuracy due to individual characteristics of the sensor elements.

In the case of the ink cartridge having the remaining amount detection sensor for detecting the near end, actual remaining ink amounts measured when the near end is detected are inconsistent for each ink cartridge.

Therefore, in order to prevent the idle ejection of the print head due to this inconsistency, related art ink-jet printers regard, as the remaining ink amount, an ink amount obtained by subtracting a sensor detection error margin from the remaining ink amount set as a threshold value when the near end is detected to control the subsequent print processing quantity.

As a result, an ink cartridge including the remaining amount detection sensor having a detection error margin +α with respect to the reference threshold value may be treated to reach an ink end state (i.e., a real end where there is no ink) even if the remaining ink amount is larger as much as 2α in comparison with another ink cartridge including the remaining amount detection sensor having a detection error margin −α with respect to the reference threshold value. Therefore, the amount of the unused discarded ink liquid was possibly increased.

For example, when a printing job is abruptly halted due to the ink end detected in the middle of a printing job performed for a piece of paper, that piece of paper becomes useless, so that users may feel inconvenient.

For this reason, it is preferable that the print processing quantity corresponding to the ink amount consumed from the near end to the ink end has a specific margin enough to complete a print processing job to some extent. For this purpose, the threshold value of the remaining liquid amount corresponding to the near end should be set relatively large.

However, according to related art printers in which an ink amount obtained by subtracting a detection error margin of the sensor from the remaining ink liquid amount set as a threshold value when the near end is detected is regarded as the remaining ink liquid amount to control the subsequent print processing, if the threshold value corresponding to the near end is set to be larger, the amount of the unused discarded ink liquid may be further increased.

In the case of a pressure-supply ink cartridge in which the ink liquid is stored in an ink chamber of which the volume can be compressed by a pressure generated by the pressed fluid (or pressed air) supplied to the inside of the cartridge casing, the ink pressure which varies depending on the remaining ink liquid amount has been detected.

However, if there is inconsistency in the pressure detected by the pressure sensor used as the remaining amount detection sensor when the near end is detected in the pressure-supply ink cartridge, inconsistency in the corresponding remaining liquid amount may be increased, or the print processing quantity that can be processed after the near end is detected cannot be increased.

The reason will be described with reference to FIG. 4. FIG. 4 shows a relationship between the remaining ink amount and the ink chamber pressure in a state that a predetermined pressure (in this example, 900 mm H₂O) is applied to the ink chamber in a pressure-supply ink cartridge. In FIG. 4, the horizontal axis denotes the remaining ink weight (in the unit of grams), and the vertical axis denotes the pressure in the ink chamber (in the unit of mm H₂O).

For example, referring to the relationship curve between the remaining ink amount and the pressure of FIG. 4, the ink pressure in the ink chamber is seldom changed until the remaining ink amount is reduced to 70 grams, assuming that the amount of ink liquid stored in a new cartridge is 240 grams. When the remaining ink liquid amount falls down under 70 grams, the ink pressure is slowly declined in a smooth curve shape according to the decreased remaining amount. Subsequently, when the remaining ink amount falls down under 20 grams, the ink pressure is abruptly decreased according to the decreased remaining amount.

A case that the threshold value corresponding to the near end of the remaining ink liquid amount is set to 30 grams as represented by the point a in FIG. 4 will be compared with a case that the threshold value corresponding to the near end of the remaining ink amount is set to 10 grams as represented by the point b. The remaining ink amount corresponding to the ink end is set to 3 grams as represented by the point c.

The remaining amount detection sensor of the ink cartridge is a pressure sensor for monitoring the pressure in the ink chamber, and is adapted to detect the near end when the pressure in the ink chamber reaches the threshold values a and b. In this case, as shown in the arrows d and e of FIG. 4, the pressure sensor used as the remaining amount detection sensor has inconsistency of detection accuracy within an error range of ±40 mmH₂O.

In order to obtain a sufficient print processing quantity until the ink end is reached after the near end is notified, it is preferable that the point a is selected as the threshold value corresponding to the near end.

Unfortunately, since the inclination of the relationship curve is smooth in the vicinity of the point a selected as the threshold value, the variation of the remaining ink amount corresponding to the error range d of the pressure sensor becomes about 20 grams.

On the contrary, since the inclination of the relationship curve is abrupt in the vicinity of the point b selected as the threshold value, the variation of the remaining ink amount corresponding to the error range e of the pressure sensor becomes about 4 grams.

In related art ink-jet cartridges and ink-jet printers, in which an ink amount obtained by subtracting a sensor detection error margin from the remaining ink liquid amount set as the threshold value when the near end is detected is regarded as the remaining ink liquid amount to control the subsequent print processing, the ink cartridge may be discarded without using an ink amount of 20 grams corresponding to the detection error of the sensor when the point a is selected as a threshold value.

Finally, the threshold value which is the near end should be selected from a region having an abrupt inclination and a small variation of the remaining ink liquid amount, so that the threshold value which is the near end has little selection freedom. Therefore, it is impossible to increase the print processing quantity after the near end is detected.

### SUMMARY OF THE INVENTION

Accordingly, an object of the present invention is to solve the above problem, and provide a liquid container and a liquid ejection device, in which the remaining liquid amount in the container case can be accurately detected regardless of the detection error of the remaining amount detection sensor.

According to an aspect of the present invention, there is provided liquid container for storing a liquid supplied to a liquid ejection device in a container case, the liquid container comprising:

a liquid supply port which allows the liquid stored in the container case to be supplied to the liquid ejection device by connecting a liquid supply needle provided in a container mounting portion when the liquid container is mounted on the container mounting portion of the liquid ejection device;

a remaining amount detection sensor which outputs a predetermined electric signal for notifying a controller of the liquid ejection device of a fact that a remaining liquid amount reaches a near end when the stored remaining liquid amount is consumed to a threshold value which is the near end; and

an information memory from/to which information is readable and writable by the controller of the liquid ejection device,

wherein the information memory stores correction information for correcting a detection error of the remaining amount detection sensor when the near end is detected such that the controller of the liquid ejection device accurately detects an actual remaining liquid amount stored in the liquid container when the remaining amount detection sensor detects the near end.

In the above construction of the liquid container, the controller of the liquid ejection device to which the liquid is supplied from the mounted liquid container corrects the detection error of the remaining amount detection sensor on the basis of the correction information stored in the information memory of the liquid container when the near end is notified from the remaining amount detection sensor of the liquid container. As a result, it is possible to accurately detect the remaining liquid amount when the near end is detected.

In addition, an ejectable liquid amount that can be ejected until a predetermined real end is reached is set on the basis of the detected accurate remaining liquid amount to control the subsequent liquid ejection processing, so that the liquid remained in the liquid container and discarded after the real end is determined regardless of the detection error of the remaining amount detection sensor can be standardized to a significantly small amount. As a result, it is possible to solve a problem that the amount of the discarded liquid increases due to the detection error of the remaining amount detection sensor.

In addition, the detection error of the remaining amount detection sensor can be corrected on the basis of the correction information stored in the information memory. Therefore, when the threshold value which is the near end is set based on the relationship between the remaining liquid amount in the liquid container and the physical amount detected by the remaining amount detection sensor, it is possible to set the threshold value which is the near end without any problem even in an area where the detection error of the remaining amount detection sensor significantly increases the detection error of the remaining ink amount.

In the above construction of the liquid container, it is preferable that the liquid is stored in a liquid chamber of which a volume can be compressed by a pressure caused by a pressed fluid supplied into the inside of the container case, and the remaining detection sensor detects the liquid pressure in the liquid chamber when the remaining liquid amount is consumed to the threshold value which is the near end.

According to this construction, it is possible to use a pressure-supply liquid container, and standardize the remaining liquid amount at the real end in the pressure-supply liquid container to a specified significantly small amount. Therefore, it is possible to reduce the discarded liquid amount.

In the above construction of the liquid container, it is preferable that the information memory stores, as the correction information, a corrected pressure obtained by subtracting an error margin from a pressure detected by the remaining amount detection sensor.

According to this construction, relationship data between the remaining liquid amount in the liquid container and the liquid pressure is previously obtained through experiments or the like and stored in the controller of the liquid ejection device as the correction information. As a result, it is possible to detect an accurate remaining liquid amount at the near end by comparing the corrected pressured stored in the information memory with reference data regardless of the detection error of the remaining amount detection sensor.

In the above construction of the liquid container, it is preferable that the information memory stores, as the correction information, an actual liquid amount consumed until a real end where the remaining liquid amount in the liquid container is considered to be actually empty is reached after the remaining amount detection sensor detects the near end.

According to this construction, the liquid ejection device sets the actual liquid amount stored in the information memory as the correction information to the liquid ejection amount after the near end if the near end is notified from the remaining amount detection sensor, ejects the actual liquid amount stored as the correction information regardless of the detection error of the remaining amount detection sensor, and determines the real end. As a result, it is possible to standardize the remaining liquid amount in the liquid container to a significantly small amount.

In other words, the setting of the liquid ejection amount after the near end is detected can be performed by just reading the actual liquid amount stored in the information memory and does not require any complicated operation processing. Therefore, it is possible to reduce the processing load on the controller of the liquid ejection device.

In the above construction of the liquid container, it is preferable that the information memory stores, as the correction information, a difference between an actual liquid amount consumed until a real end where the remaining liquid amount in the liquid container is considered to be actually empty is reached after the remaining amount detection sensor detects the near end and a predetermined setup liquid amount consumed from the near end to the real end.

According to this construction, when the near end is notified from the remaining amount detection sensor, the liquid ejection device sets a total amount obtained by adding the difference stored in the information memory as the correction information to the setup liquid amount as the liquid ejection amount after the near end. The liquid ejection device ejects a total amount obtained by adding the difference to the setup liquid amount, stored as the correction information, regardless of the detection error of the remaining amount detection sensor, and then, determines the real end. As a result, it is possible to standardize the remaining liquid amount in the liquid container to a significantly small amount.

According to another aspect of the present invention, there is provided a liquid container for storing a liquid supplied to a liquid ejection device in a container case, the liquid container comprising:

a liquid supply port which allows the liquid stored in the container case to be supplied to the liquid ejection device by connecting a liquid supply needle provided in a container mounting portion when the liquid container is mounted on the container mounting portion of the liquid ejection device;

a remaining amount detection sensor which outputs a predetermined electric signal for notifying a controller of the liquid ejection device of a fact that a remaining liquid amount reaches a near end when the stored remaining liquid amount is consumed to a threshold value which is the near end; and

an information memory from/to which information is readable and writable by the controller of the liquid ejection device,

wherein the information memory includes a write area to which information corresponding to the liquid amount at the shipping time from a factory is written, and

wherein a total amount obtained by adding, to a liquid amount at the shipping time from a factory, a difference between an actual liquid amount consumed until a real end where the remaining liquid amount in the liquid container is considered to be actually empty is reached after the remaining amount detection sensor detects the near end and a predetermined setup liquid amount consumed from the near end to the real end, is stored in the write area as the correction information.

According to this construction of the liquid container, when the near end is notified from the remaining amount detection sensor, the liquid ejection device calculates the liquid ejection amount after the near end, on the basis of a predetermined liquid amount at the shipping time from a factory and a total amount obtained by adding the difference between the actual liquid amount written as the correction information and the setup liquid amount to the liquid amount at the shipping time from a factory. In addition, the liquid ejection device ejects the liquid ejection amount regardless of the detection error of the remaining amount detection sensor and then, determines the real end, so that it is possible to standardize the remaining amount of the liquid container to a significantly small amount. In this case, the liquid ejection amount after the near end is calculated by adding the difference between the actual liquid amount and the setup liquid amount, obtained from the difference between the total amount previously written as the correction information and the liquid amount at the shipping time from a factory to a predetermined setup liquid amount.

In addition, since the correction information can be written to the write area of the information memory, to which information corresponding to the liquid amount at the shipping time from a factory is previously written, there is no need to newly form an area for writing the correction information.

In the above construction of the liquid container, it is preferable that the liquid amount at the shipping time from a factory is an actual charge amount actually charged in the liquid container.

According to this construction, it is possible to calculate the liquid ejection amount after the near end by adding the difference between the actual liquid amount and the setup liquid amount obtained from the difference between the total amount written as the correction information and the actual charge amount to a predetermined setup liquid amount.

In addition, in the above construction of the liquid container, it is preferable that the liquid amount at the shipping time from a factory is a predetermined usable amount.

According to this construction, it is possible to calculate the liquid ejection amount after the near end by adding the difference between the actual liquid amount and the setup liquid amount, obtained from the difference between the total amount written as the correction information and the usable amount, to a predetermined setup liquid amount.

According to still another aspect of the present invention, there is provided a liquid ejection device comprising a container mounting portion on which the aforementioned liquid container is mounted, wherein the controller is notified of the near end from the remaining amount detection sensor, sets an ejectable liquid amount that can be ejected until the real end is reached on the basis of the correction information stored in the information memory, and controls each unit such that the liquid is not ejected in excess of the set ejectable liquid amount.

According to the above construction of the liquid ejection device, it is possible to accurately detect the remaining liquid amount in the container case regardless of the detection error of the remaining amount detection sensor when the near end is notified from the liquid container. Therefore, it is possible to standardize the liquid amount remained in the liquid container at the real end to a significantly small amount, and solve the problem that the unused discarded liquid amount is increased.

In addition, since the liquid amount remained in the liquid container at the near end can be accurately detected, it is possible to more accurately control the liquid amount consumed from the near end to the real end by executing a software count such as dot count for the droplet ejected from the liquid ejection device. Accordingly, it is possible to reliably prevent an idle ejection of the liquid ejection device generated when all of the liquid is improvidently used. Therefore, it is possible to improve operation reliability of the liquid ejection device.

In the liquid container and the liquid ejection device according to the present invention, the controller of the liquid ejection device to which the liquid is supplied from the mounted liquid container corrects the detection error of the remaining amount detection sensor on the basis of the correction information stored in the information memory of the liquid container when the near end is notified from the remaining amount detection sensor of the liquid container. As a result, it is possible to accurately detect the remaining liquid amount when the near end is detected.

Furthermore, an ejectable liquid amount that can be ejected until a predetermined real end is reached is set on the basis of the detected accurate remaining liquid amount to control the subsequent liquid ejection processing, so that the liquid remained in the liquid container and discarded after the real end is determined regardless of the detection error of the remaining amount detection sensor can be standardized to a significantly small amount. As a result, it is possible to solve a problem that the amount of the discarded liquid increases due to the detection error of the remaining amount detection sensor.

In addition, the detection error of the remaining amount detection sensor can be corrected on the basis of the correction information stored in the information memory. Therefore, when the threshold value which is the near end is set based on the relationship between the remaining liquid amount in the liquid container and the physical amount detected by the remaining amount detection sensor, it is possible to set the threshold value which is the near end without any problem even in an area where the detection error of the remaining amount detection sensor significantly increases the detection error of the remaining ink amount.

### BRIEF DESCRIPTION OF THE DRAWINGS

FIG. 1 is a schematic diagram illustrating an ink cartridge and an ink-jet printer corresponding to a liquid container and a liquid ejection device according to the first embodiment of the present invention;

FIG. 2 is a schematic diagram illustrating an ink cartridge and an ink-jet printer corresponding to a liquid container and a liquid ejection device according to the second embodiment of the present invention;

FIG. 3 is a vertically cross-sectional view illustrating an ink cartridge corresponding to a liquid container according to the third embodiment of the present invention; and

FIG. 4 is a relationship graph between a pressure in an ink chamber and a remaining ink amount in a pressure-supply ink cartridge.

### DETAILED DESCRIPTION OF THE INVENTION

Hereinafter, a liquid container and a liquid ejection device according to preferred embodiments of the present invention will be described in detail with reference to the accompanying drawings.

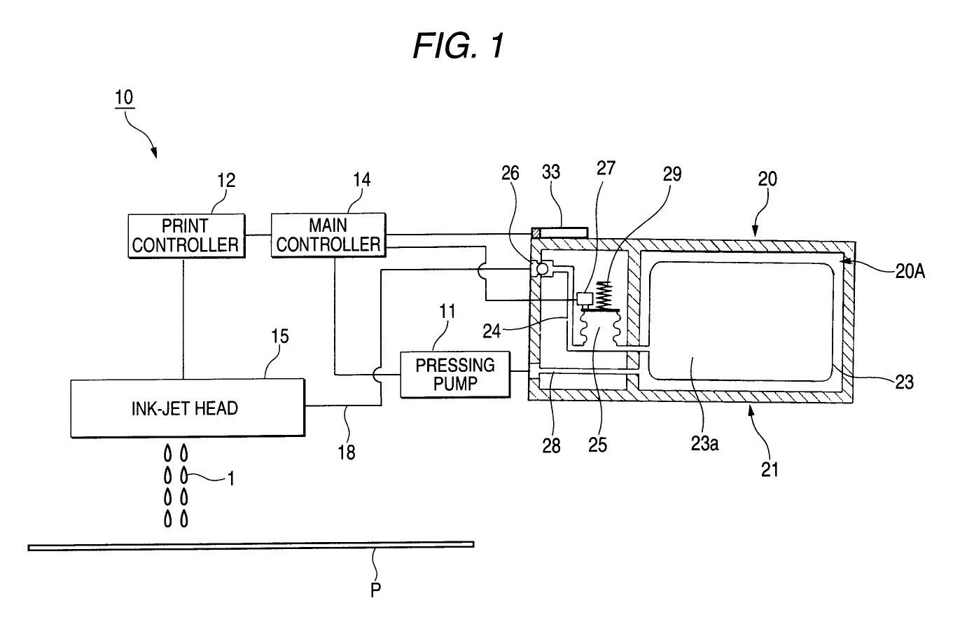

FIG. 1 is a schematic diagram illustrating a liquid container and a liquid ejection device according to the first embodiment of the present invention.

The ink-jet printer 10 shown in FIG. 1 corresponds to the liquid ejection device of the present invention, and the ink cartridge 20 detachably mounted on the ink-jet printer 10 corresponds to the liquid container of the present invention.

In the ink-jet printer 10 according to the first embodiment of the present invention, if the air is ejected into the internal space 20a of the ink cartridge 20 by the pressing pump 11 through the air inlet guide 28, the ink pouch 23 arranged in the internal space 20A is pressed by the air such that its volume is compressed. Accordingly, the ink in the ink pouch 23 is pushed out from the liquid supply port 26 connected to the ink pouch 23 toward the ink supply tube 18 of the printer and supplied to the ink-jet head (i.e., a print head) 15.

The ink-jet head 15 is, for example, a piezoelectric type ink-jet head driven by a driving pulse supplied from the print controller 12 of the printer. An ink droplet 1 is ejected onto a paper P according to the driving pulse to write characters or images on the paper P.

Operation of the pressing pump 11 or the print controller 12 is controlled by the main controller 14 provided in the inside of the printer. The main controller 14 controls operations of each unit by deploying a predetermined software program (or a firm ware) stored in a read-only memory (ROM) on a random access memory (RAM) and executing it by the central processing unit (CPU).

The ink cartridge 20 is formed in such a way that a cartridge casing 21 corresponding to a container case having a box shape encloses a closed internal space 20A for storing the ink pouch 23.

The ink cartridge 20 stores the ink liquid supplied to the ink-jet head 15 of the ink-jet printer 10 in the ink pouch 23, and includes: a liquid supply port 26 for allowing the ink liquid stored in the ink pouch 23 to be supplied to the ink supply tube 18 of the printer by connecting a liquid supply needle (not shown in the drawing) provided in the cartridge mounting portion when the ink cartridge is mounted on the cartridge mounting portion (i.e., a container mounting portion) of the ink-jet printer 10; a remaining amount detection sensor 27 which outputs a predetermined electric signal for notifying the main controller 14 of the ink-jet printer 10 of a fact that the remaining amount of the ink liquid reaches the near end when the remaining ink liquid amount stored in the ink pouch 23 is consumed to the threshold value which is the near end; and an information memory 33 from/to which information is readable and writable by the main controller 14 of the ink-jet printer 10.

In addition, the information memory 33 stores correction information for correcting a detection error of the remaining amount detection sensor 27 when the near end is detected in order to allow the main controller 14 to accurately detect the actual remaining ink amount in the ink pouch 23 when the near end is detected by the remaining amount detection sensor 27.

In this embodiment, the ink pouch 23 of the ink cartridge 20 has an ink chamber 23a of which the volume can be compressed by the pressure generated by the pressed fluid (or the pressed air) supplied from the pressing pump 11 to the internal space 20A of the cartridge casing 21.

Accordingly, the ink cartridge 20 constitutes a pressure-supply liquid container in which the ink liquid stored in the ink pouch 23 is supplied to the ink supply tube 18 by pressing the ink pouch 23 in the cartridge casing 21 with the pressed air supplied from the pressing pump 11.

The remaining amount detection sensor 27 is a sensor for detecting a predetermined pressure based on a fact that the volume of a buffer chamber 25 is changed by the pressure change of the ink flew from the ink chamber 23a, and constructed such that the detection signal is output when the volume of the buffer chamber 25 corresponding to the predetermined pressure is reached.

The buffer chamber 25 is connected to an ink flow path 24 which interconnects between the ink chamber 23a and the ink supply port 26 as well as is disposed in an area separated from the pressure of the pressed fluid.

The buffer chamber 25 is always biased to compress its volume by a spring 29, and this biasing force is designed to be smaller than the pressure of the pressed fluid. In other words, the biasing force is designed such that the buffer chamber 25 is inflated to its limitation during the ink can be supplied from the ink chamber 23a, and compressed when the ink stored in the ink chamber 23a is exhausted.

Accordingly, the remaining amount detection sensor 27 detects an ink liquid pressure in the ink chamber 23a when the remaining ink amount in the ink chamber 23a is exhausted to the threshold value which is the near end.

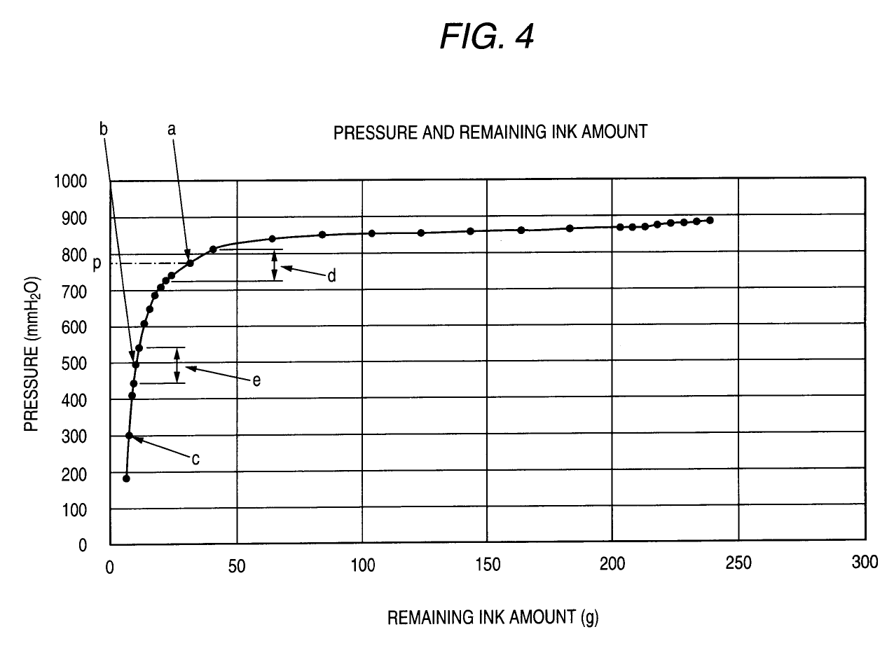

The pressure of the ink liquid in the ink chamber 23a is reduced as the remaining ink amount is decreased. This relationship is shown in the curve of FIG. 4.

In this embodiment, a detection error margin is previously determined through a product inspection or a performance test under the same condition as common use. For example, if a detection error margin is set to +α with respect to the reference threshold value, a corrected pressure obtained by subtracting the error margin +α from the detected pressure (i.e., an actual pressure) of the remaining amount detection sensor 27 is stored in the information memory 33 as corrected information. Specifically, referring to FIG. 4, the detected pressure for the threshold value a when the ink chamber 23a is pressed by the pressed fluid to a pressure of 900 mmH₂O is corrected to a pressure p of 780 mmH₂O corresponding to the threshold value a on the relationship curve.

The main controller 14 of the ink-jet printer 10 previously stores relationship data between the remaining ink amount and the ink liquid pressure of FIG. 4 in a predetermined information memory unit. When the main controller 14 is notified of the near end from the remaining amount detection sensor 27, the corrected pressure is read from the correction information stored in the information memory 33 of the ink cartridge 20, and compared with the relationship data of FIG. 4, in order to accurately detect the remaining ink liquid amount at the near end. For example, when the threshold value which is the near end is set to the point a of FIG. 4, the remaining ink amount is corrected to 30 grams corresponding to the point a.

A setup ink amount (a−c=27 grams) ejectable until a predetermined ink end (e.g., 3 grams) is reached is set, and a software count such as a dot count is performed for the ink droplet ejected from the ink-jet head 15 in such a way that the liquid is not ejected in excess of the setup ink amount (or a setup liquid amount), so as to accurately manage consumption of the ink liquid until the ink end (i.e., a real end) is reached.

In other words, the main controller 14 of the ink-jet printer 10 on which the aforementioned ink cartridge 20 is mounted corrects the detection error of remaining amount detection sensor 27 by using the correction information stored in the information memory 33 of the ink cartridge 20 when the near end is notified from the remaining amount detection sensor 27 of the ink cartridge 20, so as to accurately detect the remaining ink liquid amount when the near end is detected.

In addition, the main controller 14 sets an ejectable ink liquid amount that can be ejected until a predetermined ink end is reached on the basis of the accurately detected remaining ink liquid amount, and controls subsequent printing processes, so that it is possible to standardize the ink liquid, remained in the ink cartridge and discarded after the ink end is detected, to a predetermined significantly small amount regardless of the detection error of the remaining amount detection sensor 27. As a result, it is possible to prevent increase of the ink amount discarded due to the detection error of the remaining amount detection sensor 27.

In addition, since the remaining ink amount consumed until the ink end is reached can be accurately perceived, it is possible to reliably prevent an idle ejection of the ink-jet head 15 caused by improvidently exhausting the ink liquid, and thus, improve reliability of printer operation.

In addition, the detection error of the remaining amount detection sensor 27 can be corrected on the basis of the correction information stored in the information memory 33. Therefore, even if the threshold value is set by referring to an area (for example, a range where the remaining ink amount is 20 to 50 grams in FIG. 4) where the detection error of the remaining amount detection sensor 27 significantly increases the detection error of the remaining ink liquid amount when the threshold value which is the near end is set based on the relationship graph between the remaining ink amount and the ink liquid pressure as shown in FIG. 4, the amount of the ink liquid discarded due to the detection error of the remaining amount detection sensor 27 is not increased.

Therefore, it is possible to set the threshold value which is the near end in an area where the amount of the ink liquid is relatively large, and it is possible to increase setup freedom for the threshold value which is the near end.

In addition, it is possible to set the print processing quantity that can be processed after the near end is reached to a sufficiently large quantity according to usage of the printer by setting the threshold value which is the near end in an area where the remaining ink amount is relatively large. Therefore, it is possible to increase user's convenience of the printer by preventing problems caused by detecting the ink end in the middle of the printing job.

In addition, in the ink cartridge 20 of the present embodiment, the remaining ink liquid amount at the ink end can be standardized to a specified significantly small amount even if a pressure-supply ink cartridge capable of easily storing a large capacity of the ink liquid amount is used, so that the amount of the discarded ink liquid can be reduced.

In addition, in a business ink-jet printer having the pressure-supply ink cartridge in order to reduce a cartridge exchange frequency, it is possible to reduce cost of a printing job by decreasing the amount of the unused discarded ink liquid due to the detection error of the remaining amount detection sensor 27.

In addition, the print processing quantity processed after the near end is reached can be arbitrarily increased by setting the threshold value which is the near end depending on a paper size or the like in order to allow the near end not to be improvidently reached. Therefore, it is possible to increase user's convenience in a printing job.

When the corrected pressure obtained by subtracting the error margin from the detected pressure of the remaining amount detection sensor 27 is stored in the information memory 33 of the ink cartridge 20 as correction information as described in the present embodiment, the main controller 14 of the ink-jet printer 10 may store relationship data between the remaining ink amount and the ink liquid pressure in the ink chamber 23a previously obtained through experiments or the like.

As a result, it is possible to detect the accurate remaining ink amount when the near end is reached in a simple way by comparing the corrected pressure stored in the information memory 33 with the reference data regardless of the detection error of the remaining amount detection sensor 27.

If the remaining amount detection sensor 27 is a pressure sensor for measuring the ink liquid pressure in the buffer chamber 25 connected to the ink chamber 23a as described in the present embodiment, the correction information for correcting the detection error of the remaining amount detection sensor 27 is not limited to the corrected pressure described in the above embodiment. For example, the error margin of the detection error may be stored as the correction information, or other accurate physical information obtained from the relationship data shown in FIG. 4 may be used as the correction information.

For example, an actual ink liquid amount (for example, 28 grams) consumed until the ink end, where the remaining ink amount in the ink cartridge 20 is considered to be actually empty, is detected after the remaining amount detection sensor 27 detects the near end may be stored in the information memory 33 as the correction information.

According to this construction, the main controller 14 of the ink-jet printer 10 may set the actual ink liquid amount stored as the correction information in the information memory 33 as the ink liquid ejection amount ejected after the near end is reached when the near end is notified from the remaining amount detection sensor 27, and determine the ink end after the actual ink liquid amount stored as the correction information is ejected regardless of the detection error of the remaining amount detection sensor 27. As a result, it is possible to standardize the remaining ink liquid in the ink cartridge 20 to a significantly small amount.

In other words, the setting of the ink liquid ejection amount after the near end is detected may be performed by just reading out the actual ink liquid amount stored in the information memory 33, without necessity of a complicated operation processing such as a comparison processing of the relationship data shown in FIG. 4 or a calculation processing of the difference between the near end and the ink end. Therefore, it is possible to reduce the load on the main controller 14 and guarantee a high speed processing.

In addition, the actual ink liquid amount (for example, 28 grams) consumed until the ink end, where the remaining ink amount in the ink cartridge 20 is considered to be empty, is reached after the remaining amount detection sensor 27 detects the near end, and setup ink liquid amount (for example, 27 grams) consumed from the near end to the ink end may be stored in the information memory 33 as the correction information.

According to this construction, the main controller 14 of the ink-jet printer 10 sets a sum (28 grams) of the difference (i.e., 1 gram) stored in the information memory 33 as the correction information and the setup ink liquid amount (27 grams) as the ink liquid ejection amount ejected after the near end is reached when the near end is notified from the remaining amount detection sensor 27. In addition, the main controller 14 of the ink-jet printer 10 performs determination of the ink end after the sum (28 grams) of the setup ink liquid amount (27 grams) and the difference (1 gram) stored as the correction information is ejected regardless of the detection error of the remaining amount detection sensor 27. As a result, it is possible to standardize the remaining ink amount in the ink cartridge 20 to a significantly small amount.

In addition, the information memory 33 of the ink cartridge 20 may include a write area to which information corresponding to a liquid amount at the shipping time from a factory (e.g., the amount of ink actually charged in the ink cartridge in a factory manufacturing) is written.

Accordingly, the correction information corresponding to the total amount (241 grams) obtained by adding the difference (e.g., 1 gram) between the actual ink liquid amount (e.g., 28 grams) consumed until the ink end, where the remaining ink amount in the ink cartridge 20 is considered to be actually empty, is reached after the remaining amount detection sensor 27 detects the near end, and the setup ink amount (e.g., 27 grams) consumed from the near end to the ink end to the manufacturing ink amount (e.g., 240 grams) actually charged in the ink cartridge 20 in a factory manufacturing may be written to the write area of the information memory 33.

According to this construction, the main controller 14 of the ink-jet printer 10 calculates the liquid ejection amount consumed after the near end is reached based on the predetermined ink amount (e.g., 240 grams) actually charged in a factory manufacturing and the total amount (e.g., 241 grams) written to the write area of the information memory 33 as the correction information when the near end is notified from the remaining amount detection sensor 27. In this case, the difference (e.g., 1 gram) between the actual liquid amount and the setup liquid amount, obtained from the difference between the total amount (e.g., 241 grams) written as the correction information and the actual ink amount (240 grams) actually charged in a factory manufacturing, is added to the predetermined setup ink amount (e.g., 27 grams) to calculate the liquid ejection amount (e.g., 28 grams) consumed after the near end is reached.

In addition, the main controller 14 of the ink-jet printer 10 determines the ink end after the calculated liquid ejection amount (28 grams) is ejected regardless of the detection error of the remaining amount detection sensor 27. As a result, it is possible to standardize the remaining ink amount in the ink cartridge 20 to a significantly small amount.

In addition, the correction information can be written to the write area of the information memory 33, where the information corresponding to the actual ink amount actually charged in a factory manufacturing is stored. Therefore, there is not need to newly provide an area for writing the correction information.

The liquid amount at the shipping time from a factory written to the write area of the information memory 33, is not limited to the ink amount (e.g., 240 grams) actually charged in the ink cartridge 20, but may be a predetermined usable amount (e.g., 237 grams).

In this case, the correction information corresponding to a total amount (238 grams) obtained by adding the difference (1 gram) between the actual ink liquid amount (e.g., 28 grams) consumed until the ink end, where the remaining ink amount in the ink cartridge 20 is actually empty, is reached after the remaining amount detection sensor 27 detects the near end and the setup ink amount (e.g., 27 grams) consumed from the near end to the ink end to a predetermined usable amount (e.g., 237 grams) is written to the write area of the information memory 33.

Accordingly, the main controller 14 of the ink-jet printer 10 calculates a liquid ejection amount to be ejected after the near end on the basis of a predetermined usable amount (e.g., 237 grams) and a total amount (e.g., 238 grams) written in the write area of the information memory 33 as the correction information when the near end is notified from the remaining amount detection sensor 27. In this case, the liquid ejection amount (e.g., 28 grams) to be ejected after the near end is calculated by adding the difference (e.g., 1 gram) between the setup liquid amount and the actual liquid amount, obtained from the difference between the total amount (e.g., 238 grams) written as the correction information and the predetermined usable amount (e.g., 237 grams), to the predetermined setup ink amount (27 grams).

In addition, a method of detecting the near end in the ink cartridge 20 is not limited to the aforementioned method, in which the ink liquid pressure in the buffer chamber 25 is measured by the pressure sensor used as the remaining amount detection sensor 27.

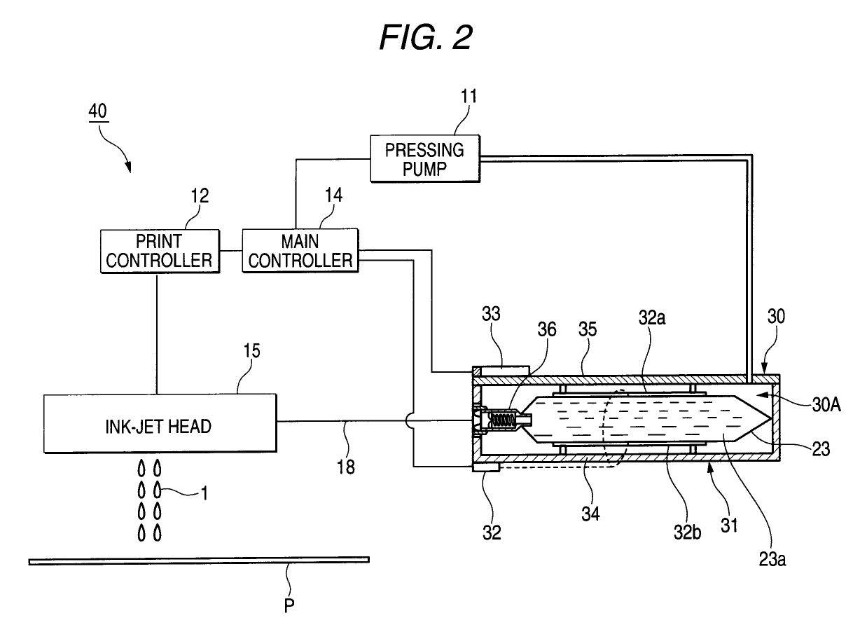

FIG. 2 illustrates an ink-jet printer 40 and an ink cartridge 30 mounted on the ink-jet printer 40 corresponding to a liquid ejection device and a liquid container according to the second embodiment of the present invention. The same reference numerals as those of the ink-jet printer 10 according to the first embodiment denote like elements, and their detailed descriptions are omitted.

In an ink cartridge 30 according to the second embodiment of the present invention, the cartridge casing 31 corresponding to the container case is constructed of a casing body 34 of which one end is opened and has a box shape, and a cover 35 for covering the opening portion of the casing body 34. The cartridge casing 31 has a closed internal space 30A for storing an ink pouch 23.

The ink cartridge 30 stores the ink liquid supplied to the ink-jet head 15 of the ink-jet printer 40 in the ink pouch 23, and includes: a liquid supply port 36 for allowing the ink liquid stored in the ink pouch 23 to be supplied to the ink supply tube 18 of the printer by connecting a liquid supply needle (not shown in the drawing) provided in the cartridge mounting portion when the ink cartridge is mounted on the cartridge mounting portion of the ink-jet printer 40; a remaining amount detection sensor 32 which outputs a predetermined electric signal for notifying the main controller 14 of the ink-jet printer 40 of a fact that the remaining ink amount reaches the near end when the remaining ink amount stored in the ink pouch 23 is consumed to the threshold value which is the near end; and an information memory 33 from/to which information is readable and writable by the main controller 14 of the ink-jet printer 40.

In addition, the information memory 33 stores correction information for correcting a detection error of the remaining amount detection sensor 32 when the near end is detected in order to allow the main controller 14 to accurately detect an actual ink liquid amount in the ink pouch 23 when the remaining amount detection sensor 32 detects the near end.

The ink pouch 23 of the ink cartridge 30 has an ink chamber 23a of which the volume can be compressed by the pressure generated by the pressed fluid (or the pressed air) supplied from the pressing pump 11 to the internal space 30A of the cartridge casing 21. The ink cartridge 30 constitutes a pressure-supply liquid container in which the ink liquid stored in the ink pouch 23 is supplied to the ink supply tube 18 by pressing the ink pouch 23 with the pressed air supplied from the pressing pump 11.

In addition, the remaining amount detection sensor 32 according to the second embodiment of the present invention has a parallel plate condenser constructed of a pair of electrode plates 32a and 32b oppositely arranged in a compressive direction with the ink pouch 23 being interposed therebetween, so that the near end of the remaining ink amount is detected using the electrostatic capacity which varies according to reduction of the remaining ink amount in the ink pouch 23.

In this case, relationship data between the electrostatic capacity and the remaining ink amount is previously collected through experiments or the like, and stored in the main controller 14. The remaining amount detection sensor 32 outputs a predetermined electric signal when the electrostatic capacity corresponding to the remaining ink amount corresponding to the threshold value which is the near end is reached. The information memory 33 of the ink cartridge 30 may store an electrostatic capacity value for correcting the detection error of the remaining amount detection sensor 32 or the accurate remaining ink amount when the near end is reached.

Even when the construction of the remaining amount detection sensor is changed, the ink cartridge 30 according to the second embodiment of the present invention can obtain the same function and effect as those of the ink cartridge 20 according to the first embodiment of the present invention.

The pressure-supply ink cartridge as a liquid container according to the present invention is not limited to an ink-back type cartridge, in which, similarly to the ink cartridge 20 (30) of each embodiment, the ink pouch 23 for storing the ink liquid is disposed in the internal space 20A (30A) of the closed cartridge casing 21 (31), and the ink pouch 23 is pressed such that its volume is compressed by the pressed air, so that ink liquid in the ink pouch 23 is pushed into the liquid supply port 26 (36).

For example, the pressure-supply ink cartridge may be constructed to include an ink chamber for storing the ink liquid in the inside of the casing body, an ink pressing room disposed in an upper portion of the ink chamber, and a flexible film interposed between the ink chamber and the ink pressing room to separate them.

According to this ink cartridge, the flexible film is pushed toward the ink chamber and deformed by the pressed air introduced to the ink pressing room, the ink liquid in the ink chamber is pressed accordingly, and the pressed ink liquid is pushed out from the liquid supply port connected to the ink chamber.

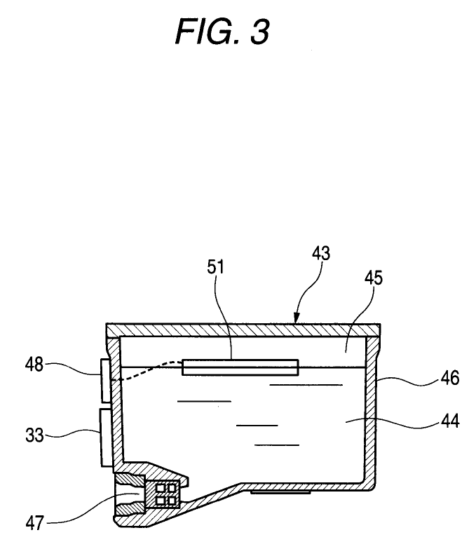

In addition, the ink cartridge used as a liquid container according to the present invention is not limited to the pressure-supply ink cartridge shown in the above embodiments. For example, a construction shown in FIG. 3 may be adopted.

The ink cartridge 43 according to the third embodiment of the present invention shown in FIG. 3 is an atmospheric open type ink cartridge. The cartridge casing 46 enclosing an ink chamber 45 for storing an ink liquid includes: an ink supply port 47 into which an ink supply needle of the printer side is inserted; an atmospheric open hole (not shown in the drawing) for introducing the external air into the ink chamber 45; a remaining amount detection sensor 48 for detecting the reaming ink liquid amount in the ink chamber 45; and an information memory 33 onto which information is readable and writable by the main controller of the printer side.

The remaining amount detection sensor 48 according to the third embodiment of the present invention is a sensor for detecting the remaining ink amount using a position of the float 51 floating on the liquid surface of the ink 44.

The ink cartridge 43 may obtain the same function and effect as those of the first and second embodiments described above by storing the information for correcting the detection error of the remaining amount detection sensor 48 in the information memory 33.

The construction of the liquid container and the liquid ejection device according to the present invention can be applied in a wide range to a liquid container for storing a medical liquid and a liquid ejection device for ejecting the medical liquid supplied from the liquid container or the like, in addition to the ink cartridge and the ink-jet printer described in the above embodiments. Specific examples of the liquid ejection device may include: a device having an head for ejecting a color pigment used to manufacture a color filter of a liquid crystal display or the like; a device including an ejection head for ejecting an electrode material (a conductive paste) used to form electrodes of an organic electroluminescent display, a field effect diode (FED) display, or the like; a device having an ejection head for ejecting a bio-organic material used to manufacture a bio-chip; and a device having an ejection head for ejecting a specimen as an accurate pipette.

Also, the remaining amount detection sensor mounted on the liquid container to detect the near end of the remaining liquid amount is not limited to the aforementioned embodiments. For example, the near end of the liquid may be detected based on voice impedance change of the stored liquid using a piezoelectric element, or various sensors known in the art may be used.

What is claimed is:

1. A liquid container for storing a liquid supplied to a liquid ejection device in a container case, the liquid container comprising:
a liquid supply port which allows the liquid stored in the container case to be supplied to the liquid ejection device by connecting a liquid supply needle provided in a container mounting portion when the liquid container is mounted on the container mounting portion of the liquid ejection device;
a remaining amount detection sensor which outputs a predetermined electric signal for notifying a controller of the liquid ejection device of a fact that a remaining liquid amount reaches a near end when the stored remaining liquid amount is consumed to a threshold value which is the near end; and
an information memory from/to which information is readable and writable by the controller of the liquid ejection device,
wherein the information memory stores correction information for correcting a detection error of the remaining amount detection sensor when the near end is detected such that the controller of the liquid ejection device accurately detects an actual remaining liquid amount stored in the liquid container when the remaining amount detection sensor detects the near end.

2. The liquid container according to claim 1, wherein the liquid is stored in a liquid chamber, a volume of the liquid chamber being compressed by a pressure caused by a pressed fluid supplied to the inside of the container case, and
wherein the remaining detection sensor detects a liquid pressure in the liquid chamber when the remaining liquid amount is consumed to the threshold value which is the near end.

3. The liquid container according to claim 2, wherein the information memory stores, as the correction information, a corrected pressure obtained by subtracting an error margin from a pressure detected by the remaining amount detection sensor.

4. The liquid container according to claim 1, wherein the information memory stores, as the correction information, an actual liquid amount consumed until a real end where the remaining liquid amount in the liquid container is considered to be actually empty is reached after the remaining amount detection sensor detects the near end.

5. The liquid container according to claim 1, the information memory stores, as the correction information, a difference between an actual liquid amount consumed until a real end where the remaining liquid amount in the liquid container is considered to be actually empty is reached after the remaining amount detection sensor detects the near end and a predetermined setup liquid amount consumed from the near end to the real end.

6. A liquid container for storing a liquid supplied to a liquid ejection device in a container case, the liquid container comprising:
a liquid supply port which allows the liquid stored in the container case to be supplied to the liquid ejection device by connecting a liquid supply needle provided in a container mounting portion when the liquid container is mounted on the container mounting portion of the liquid ejection device;
a remaining amount detection sensor which outputs a predetermined electric signal for notifying a controller of the liquid ejection device of a fact that a remaining liquid amount reaches a near end when the stored remaining liquid amount is consumed to a threshold value which is the near end; and
an information memory from/to which information is readable and writable by the controller of the liquid ejection device,
wherein the information memory includes a write area to which information corresponding to the liquid amount at the shipping time from a factory is written, and
wherein a total amount obtained by adding, to a liquid amount at the shipping time from a factory, a difference between an actual liquid amount consumed until a real end where the remaining liquid amount in the liquid container is considered to be actually empty is reached after the remaining amount detection sensor detects the near end and a predetermined setup liquid amount consumed from the near end to the real end, is stored in the write area as the correction information.

7. The liquid container according to claim 6, wherein the liquid amount at the shipping time from a factory is an actual charge amount actually charged in the liquid container.

8. The liquid container according to claim 6, wherein the liquid amount at the shipping time from a factory is a predetermined usable amount.

9. A liquid ejection device comprising a container mounting portion on which the liquid container according to any one of claims 1 to 8 is mounted, wherein
the controller is notified of the near end from the remaining amount detection sensor, sets an ejectable liquid amount that can be ejected until the real end is reached on the basis of the correction information stored in the information memory, and controls each unit such that the liquid is not ejected in excess of the set ejectable liquid amount.
